(19) United States
(12) Patent Application Publication
(10) Pub. No.: US 2009/0049708 A1
(43) Pub. Date: Feb. 26, 2009

(54) Control Method of Dryer

(76) Inventor: Jun Seok Lee, Daegu (KR)

Correspondence Address: MCKENNA LONG & ALDRIDGE LLP, 1900 K STREET, NW, WASHINGTON, DC, 20006, US

(21) Appl. No.: 12/224,495

(22) PCT Filed: Mar. 9, 2007
(86) PCT No.: PCT/KR2007/001182

§ 371 Date: Aug. 28, 2008

(30) Foreign Application Priority Data
Mar. 9, 2006 (KR) 10-2006-0022299

(51) Int. Cl. F26B 3/02

(52) U.S. Cl. 34/491

(57) ABSTRACT

The present invention relates to a control method of a dryer. More specifically, the present invention relates to control method of a dryer that includes performing drying of laundry; determining whether drying laundry for ironing out of total laundry is completed; and noticing a user that drying the laundry for ironing is completed.

### TECHNICAL FIELD

The present invention relates to a dryer. More specifically, the present invention relates to a controlling method of a dryer for lessening the drying time and reducing electricity consumption, which is convenient to a user.

### BACKGROUND ART

Generally, dryers are home appliances that are used to dry laundry by hot air supplied to a laundry holding space. There are dryers having only a drying function and laundry machines having a drying and washing function.

The dryers are typically categorized into an air exhaustion-type dryer and an air condensation-type dryer based on a drying method.

In the exhaustion-type dryer, damp air produced after drying laundry is exhausted outside. In the air condensation-type dryer, damp air produced after drying laundry is heat-exchanged with external air and the damp air is condensed to be changed into dry air. Then, the dry air is heated to be re-supplied to the laundry.

A method for controlling a conventional air condensation-type dryer will be now described in detail, referring to the drawings.

FIG. 1 is a longitudinal sectional view schematically illustrating a conventional air condensation-type dryer and FIG. 2 is a cross sectional view schematically illustrating the conventional air condensation-type dryer.

As shown in FIGS. 1 and 2, the air condensation-type dryer includes a body 10, a drum 11, a motor and a belt 19. The body 10 defines an exterior of the dryer and A door 12 is coupled to a front surface of the body 10. The drum 11 is rotatable within the body 10 and holds laundry therein. The motor 17 and the belt 19 are mounted in a lower portion of the body 10 to rotate the drum 11, communicating with each other.

The air condensation-type dryer further includes a condenser 13 and an air circulation duct 14. The condenser 13 is installed in the lower portion of the body 10. The condenser 13 condenses damp air passing the drum 11 and removes moisture from the damp air to change the damp air into dry air. Air is circulated through the circulation duct 14.

There are provided in the circulation duct 14 a heater 15 for heating the air passing through the condenser 13 and a circulation fan 16 for forcibly circulating the air.

Also, an external air supply duct 18, a cooling fan 20 and a cooling fan operation motor 21 are provided to condense the air after heat-exchanging the damp air passing the condenser 13 with external air. A water reservoir (not shown) is also provided under the condenser 13 to receive the water generated during the heat exchanging between the damp air and external air.

A method for controlling the conventional air condensation-type dryer will be now described.

Once a user introduces laundry such as clothes, cloth items and beddings into the drum 11 and operates the dryer, the motor 17 is operated to rotate the drum 11. Together with that, the heater 15 and the circulation fan 16 are operated to supply hot air to the drum 11. Thus, the drying of the laundry is performed.

Air is getting damp during the drying. The damp air passes the condenser 13 through the circulation duct 14 to be condensed and it is changed into dry air. At this time, the damp air passing the condenser 13 is heat-exchanged with external air that is forcibly ventilated to the condenser 13 by the cooling fan 20 and it is condensed to be dry air. The dry air is heated by the heater 15 and it is drawn into the drum 11 to dry the laundry. This air circulation is repeatedly performed and the laundry inside the drum 11 is dried.

### DISCLOSURE OF INVENTION

### Technical Problem

However, the above conventional air condensation-type dryer has following disadvantages as follows.

First, laundry for ironing and normal laundry should be divided out of the total laundry and the drying should be separately performed which is inconvenient to a user.

More specifically, the laundry for ironing should be dried less to be slightly damp, which enables a user to iron the laundry more conveniently. As a result, the laundry for ironing should be separated and a special drying should be selected.

Second as mentioned above, laundry for ironing and normal laundry should be separated and dried separately. Thus, the dryer should be operated twice, which may waste time and electricity.

### Technical Solution

To solve the problems, an object of the present invention is to provide a controlling method of a dryer capable of reducing drying time and electricity consumption, which is convenient to a user.

To achieve these objects and other advantages and in accordance with the purpose of the invention, as embodied and broadly described herein, a controlling method of a dryer includes: performing drying of laundry; determining whether drying laundry for ironing out of total laundry is completed; and noticing a user that drying the laundry for ironing is completed.

It is determined by sensing humidity of the laundry that drying the laundry for ironing is completed.

It is determined that drying the laundry for ironing is completed if the humidity of the laundry for ironing is below the predetermined humidity. In this case, the pre-determined humidity is higher than a predetermined humidity of normal laundry.

By the way, sounds, letters and/or lights are used for noticing a user that drying the laundry for ironing is completed.

The controlling method of a dryer further includes selecting separation of laundry for ironing, before drying laundry, wherein sensing that drying the laundry for ironing is completed and noticing a user that drying the laundry for ironing is completed are performed if the separation of laundry for ironing is selected. After noticing a user that drying the laundry for ironing is completed the controlling method of a dryer further includes determining whether the laundry for ironing is removed; and drying the remaining normal laundry, if it is determined that the laundry for ironing is removed.

It is determined by sensing a weight change of total laundry whether the laundry for ironing is removed.

After drying the remaining laundry except the laundry for ironing, the controlling method of a dryer according to the present invention further includes cooling the remaining laundry.

In another aspect of the present invention, a controlling method of a dryer includes: selecting separation of laundry for ironing out of total laundry; performing drying of the laundry and measuring humidity of the laundry for ironing during the drying; determining based on the sensed humidity whether drying the laundry for ironing is completed; noticing a user that drying the laundry for ironing is completed; determining whether the laundry for ironing is removed; and performing the drying for the remaining laundry, if it is determined that the laundry for ironing is removed.

### Advantageous Effects

A still further, due to the same advantage mentioned above, electricity consumption can be reduced as well.

A controlling method of a dryer according to the present invention has an advantageous effect of enhanced convenience, because drying laundry for ironing and drying normal laundry are performed at the same time.

Furthermore, the controlling method of a dryer according to the present invention has another advantageous effect of reduced overall drying time, because drying laundry for ironing and drying normal laundry are performed at the same time.

Still further, the controlling method of a dryer according to the present invention has another advantageous of less electricity consumption, because drying laundry for ironing and drying normal laundry are performed at the same time.

### BRIEF DESCRIPTION OF THE DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 is a longitudinal sectional view schematically illustrating a conventional air condensation-type dryer;

FIG. 2 is a cross sectional view schematically illustrating the conventional air condensation-type dryer; and

FIG. 3 is a flow chart illustrating a controlling method of a dryer according to an embodiment.

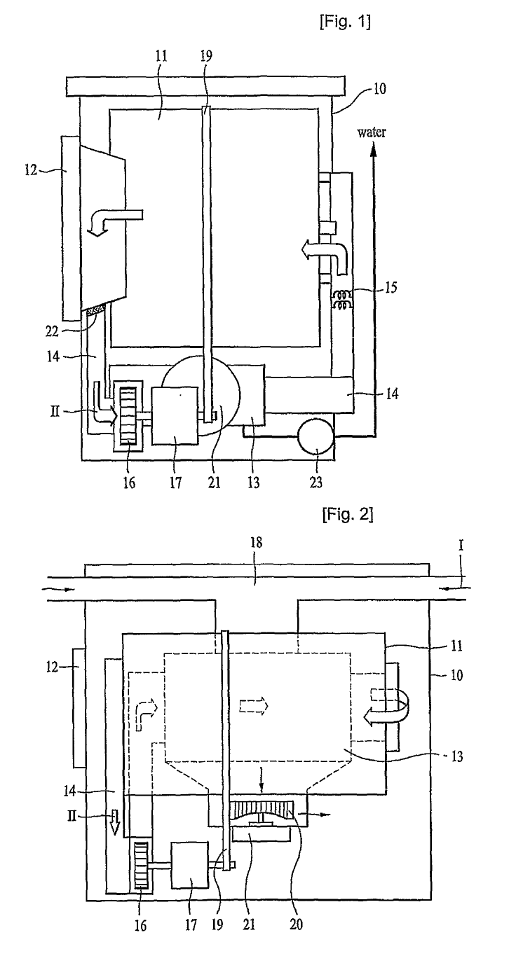

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

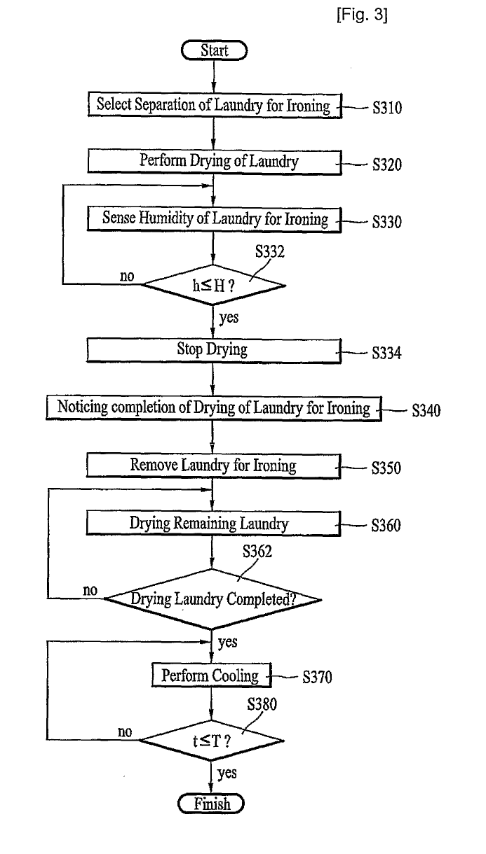

In reference to FIG. 3, the preferred embodiment will be explained.

As shown in FIG. 3, a controlling method of a dryer according to the embodiment includes a step of performing drying of laundry (S320), a step of determining whether drying laundry for ironing out of the total laundry is completed (S332) and a step of noticing a user that drying the laundry for ironing is completed (S340).

It is determined by sensing humidity (h) of the laundry (S330) that drying the laundry for ironing is completed. If the humidity (h) of the laundry is below the pre-determined humidity (H), it may be determined that drying the laundry for ironing is completed.

Although not described it is preferred that sounds, letters and/or lights are used to notice a user that drying the laundry for ironing is completed.

Specifically, if it is determined that drying the laundry for ironing is completed a controller (not shown) allows a predetermined buzzer alarmed or allows letters displayed on a LCD window provided in a control panel (not shown) or allows an LED lamp turned on/off.

The controlling method of a dryer may further includes a step of selecting separation of laundry for ironing (S310) before performing the drying of the laundry (S320).

The steps of determining that drying the laundry for ironing is completed (S332) and noticing a user that drying the laundry for ironing is completed (S340) may be performed only when the separation of laundry for ironing is selected.

That is, if a user selects the separation of laundry for ironing before the drying of the laundry starts, the steps of determining that drying laundry for ironing is completed (S332) and noticing a user that drying laundry for ironing is completed (S340) are performed.

After the step of noticing a user that drying laundry for ironing (S340) is completed the controlling method of a dryer may further includes a step of determining whether the laundry for ironing is removed (S350) and a step of performing the drying of the remaining laundry except the laundry for ironing (S360).

In other words, in the step S350, it is determined whether a user unloads the laundry for ironing out of the total laundry. When noticing a user that drying the laundry for ironing is completed the weight of total laundry is sensed and it is determined whether the weight is lessened. Thus, the user is noticed that drying the laundry for ironing is completed by the result of comparison between the two weights.

According to the controlling method of a dryer, once it is determined that the laundry for ironing is removed remaining courses of the drying may be performed.

The above controlling method of a dryer will be now explained in detail.

Once he/she loads the laundry mixed with laundry for ironing and normal laundry into the drum 11, a user selects the separation of laundry for ironing (S310) and operates the dryer.

Hence, hot air is supplied to the drum 11 by the heater 15 and the circulation fan 16. The hot air is heat-exchanged with the laundry inside of the drum 11 and it sucks the moisture contained in the laundry to dry the laundry (S320).

More specifically, the air that is getting damp after heat-exchanging with the laundry is passing the condenser 13 through the circulation duct 14. Thus, it is condensed and changed into dry air. At this time, the damp air passing the condenser 13 is heat exchanged with external air forcibly ventilated to the condenser 13 by the cooling fan 20 to be condensed. The dry air is heated by the heater 15 and drawn into the drum 11. The above air circulation is repeated to dry the laundry.

Also, a humidity sensor (not shown) provided in the drum 11 senses the humidity inside the drum 11 during the drying (S330).

The humidity (h) sensed by the humidity sensor (not shown) is compared with the predetermined humidity (H) (S332). If the sensed humidity (h) is higher than the pre-determined humidity (H), the drying is continuously performed. If the sensed humidity (h) is below the predetermined humidity (H), the drying is stopped (S334).

The predetermined humidity (H) is a humidity value for determining whether laundry for ironing is dried enough. It is preferred that the predetermined humidity (H) is higher than another predetermined humidity for normal laundry that does not need ironing.

That is, in case the drying the laundry for ironing is completed the moisture of the laundry for ironing is typically higher than the moisture of the normal laundry. The predetermined humidity of the laundry for ironing is higher than the predetermined humidity of the normal laundry. Ironing may be easy after the drying, when the laundry has a predetermined amount of moisture.

Hence, a user is noticed that drying the laundry for ironing is completed (S340).

Sounds such as buzzers, letters and/or lights having predetermined specific colors may be used to notice a user that drying the laundry for ironing is completed. Hence, the user opens the door of the dryer to take out the laundry for ironing from the drum 11 (S350).

Hence, the user closes the door and the remaining courses of the drying for remaining normal laundry may be performed for a predetermined time period (S360). The time period of the drying for the remaining normal laundry is preset. That is, it is determined whether the predetermined drying time period passes (S362) and the drying is completed if the time reaches the predetermined time period.

Once drying the normal laundry is completed as described above, the moisture contained in the normal laundry is relatively much smaller than the moisture contained in the laundry for ironing. In other words, as shown in FIG. 3, the normal laundry is dried together with the laundry for ironing (S320) and the drying is continuously performed to dry the remaining normal laundry after the laundry for ironing is removed (S360). Thus, the normal laundry has less moisture than the laundry for ironing.

Once the drying for normal laundry is completed a cooling for lowering the temperature (t) of the high-temperature laundry to the predetermined temperature (T), for example, approximately 47 is performed to allow a user to take out the laundry more smoothly (S370). More specifically, the heater 15 is stopped and only the circulation fan 16 is operated to supply air having the relatively lower temperature to the drum 11 until the temperature of the hot laundry is lowered to the predetermined temperature (T) (S380).

Once the cooling is completed a user may take out the dried laundry from the drum.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention has an industrial applicability.

First, drying laundry for ironing and drying normal laundry are performed at the same time, which is convenient to a user.

Furthermore, as mentioned above, drying laundry for ironing and drying normal laundry are performed at the same time, which can reduce the overall drying time.

A still further, due to the same advantage mentioned above, electricity consumption can be reduced as well.

1. A controlling method of a dryer comprising:
performing drying for laundry
determining whether drying laundry for ironing out of the total laundry is completed; and
noticing a user that drying the laundry for ironing is completed.

2. The controlling method of a dryer as claimed in claim 1, wherein it is determined by sensing humidity of the laundry that drying the laundry for ironing is completed.

3. The controlling method of a dryer as claimed in claim 2, wherein it is determined that drying the laundry for ironing is completed if the humidity of the laundry for ironing is below the predetermined humidity.

4. The controlling method of a dryer as claimed in claim 3, wherein the pre-determined humidity is higher than a predetermined humidity of normal laundry.

5. The controlling method of a dryer as claimed in claim 1, wherein sounds, letters and/or lights are used for noticing a user that drying the laundry for ironing is completed.

6. The controlling method of a dryer as claimed in claim 1, further comprising:
selecting separation of laundry for ironing, before drying laundry, wherein sensing that drying the laundry for ironing is completed and noticing a user that drying the laundry for ironing is completed are performed if the separation of laundry for ironing is selected.

7. The controlling method of a dryer as claimed in claim 1, after noticing a user that drying the laundry for ironing is completed further comprising:
determining whether the laundry for ironing is removed; and
drying the remaining laundry, if it is determined that the laundry for ironing is removed.

8. The controlling method of a dryer as claimed in claim 7, wherein it is determined by sensing weight change of total laundry whether the laundry for ironing is removed.

9. The controlling method of a dryer as claimed in claim 7, after drying the remaining laundry except the laundry for ironing, further comprising:
cooling the remaining laundry.

10. A controlling method of a dryer comprising:
selecting separation of laundry for ironing out of total laundry;
performing drying for the laundry and measuring humidity of the laundry for ironing during the drying;
determining based on the sensed humidity whether drying the laundry for ironing is completed; and
noticing a user that drying the laundry for ironing is completed;
determining whether the laundry for ironing is removed; and
performing the drying for the remaining laundry, if it is determined that the laundry for ironing is removed.
